(19) United States
(12) Patent Application Publication
(10) Pub. No.: US 2005/0024688 A1
(43) Pub. Date: Feb. 3, 2005

(54) Office machine

(76) Inventors: Yukiko Inada, Akishima-shi (JP); Takezo Fujishige, Yokohama-shi (JP)

Correspondence Address: MORRISON & FOERSTER LLP, 1650 TYSONS BOULEVARD, SUITE 300, MCLEAN, VA, 22102, US

(21) Appl. No.: 10/902,600

(22) Filed: Jul. 30, 2004

(30) Foreign Application Priority Data
Jul. 31, 2003 (JP) 2003-205179

(51) Int. Cl. G06F 15/00; H04N 1/00

(52) U.S. Cl. 358/400; 358/1.15

(57) ABSTRACT

A console section having an operation unit is connected to a console moving mechanism. When an upward and downward sliding unit of the console moving mechanism moves upon a guide rail of a support pillar, the console section moves upward or downward. When a lateral direction sliding unit moves upon a guide rail of the upward and downward sliding unit, the console section moves in the lateral direction. When a frontward and backward sliding unit moves upon a guide rail of the lateral direction sliding unit, the console section moves frontward or backward. When a rotational moving unit rotates, the console section rotates. Due to these movements, a user can operate the operation unit by moving the console section to a position at which he/she can easily use the operation unit.

### BACKGROUND OF THE INVENTION

1. Field of the Invention

The present invention relates to an office machine such as a multifunction copying machine, etc. and an operation unit thereof, and particularly to an office machine such as a multifunction copying machine, etc. having a movable operation unit.

2. Description of the Related Art

Recently, multifunction copying machines which provide a function of generating hardcopies of document scripts, a function of sending and receiving facsimile data, and a function of reading (scanning) image data from scripts, all by themselves have become popular (for example, Unexamined Japanese Patent Application KOKAI Publication No. H11-202697).

Generally, users of multifunction copying machines push a copying operation button when generating a copy, and click a print icon of a personal computer when printing a document or screen image from the personal computer. When using a scanner function, users put the script on a script mounting and set the machine to a scanner mode so that the script may be scanned and image data may be read.

### SUMMARY OF THE INVENTION

However, the operation unit of conventional multifunction copying machines is fixed to a predetermined position of the machines. Particularly, the operation unit of a tall multifunction copying machine whose paper discharge part is provided inside the machine body (for example, in-trunk sheet discharge type machine), is fixed at a high position. Therefore, there has been a problem that these machines can not easily be used by short users or physically disabled people in wheelchairs.

The same problem is shared by other office machines, especially, comparatively tall machines.

The present invention was made in view of the above-described circumstance, and an object of the present invention is to realize an office machine whose operation unit can easily be operated by users.

To achieve the above object, an office machine according to a first aspect of the present invention is an office machine which has an operation unit, and comprises: a housing; a processing unit which operates in accordance with a content of an instruction from an operator of the office machine and which is provided inside the housing; and an operation unit which is formed so as to be movable with respect to the housing.

For example, the office machine comprises: a printing section which performs printing on a sheet of paper; and a discharging section of an in-trunk sheet discharge type which discharges a sheet of paper on which printing is performed by the printing section.

For example, this office machine comprises a stopper which supports the operation unit so as not to move with respect to the housing, when the office machine is operating.

For example, the operation unit is formed so as to be movable in a frontward and backward direction when seen from an operator of the office machine.

For example, the operation unit is formed so as to be movable in an upward and downward direction when seen from an operator of the office machine.

For example, the operation unit is formed so as to be movable in a leftward and rightward direction when seen from an operator of the office machine.

For example, the operation unit is supported rotatably about a predetermined horizontal axis. In this case, the office machine comprises a holding member which holds the operation unit at an arbitrary angle to a horizontal plane.

It is preferred that the office machine comprise a driving unit which moves the operation unit to a position desired by an operator in accordance with an instruction from the operator.

It is preferred that the office machine comprise a storage unit which stores setting information representing displacement from a home position for each operator. In this case, the processing unit activates the driving unit in accordance with the setting information in order to control the driving unit to move the operation unit to a position desired by an operator.

In this office machine, the operation unit may include an input unit which acquires verification data for verifying an operator. In this case, the storage unit stores the verification data for each operator in one to one correspondence to the setting information, and the office machine comprises a determination unit which determines whether or not verification data input from the input unit is stored in the storage unit. And the processing unit, in a case where the determination unit determines that verification data input from the input unit is stored in the storage unit, activates the driving unit to move the operation unit to a position desired by a operator based on setting information associated with the input verification data, and in a case where the determination unit determines that verification data input from the input unit is not stored in the storage unit, stores displacement of the operation unit from the home position at a time in question, in the storage unit as setting information in association with the verification data input from the input unit.

To achieve the above object, an office machine according to a second aspect of the present invention comprises a housing; a printing section; a discharging section which discharges a printed sheet of paper; an operation unit for inputting an instruction to at least the printing section; and an operation unit supporting section which supports the operation unit in a manner that the operation unit is movable with respect to the housing.

According to these configurations, by moving the operation unit closer or to a lower position, short users or users in wheelchairs can easily operate the operation unit.

The operation unit may be designed to be rotatable about a horizontal axis so that it can be inclined. With this design, short users or the like no longer need to take a hart position in order to overlook the operation unit.

Further, the operation unit may be designed to be movable downward first and then rotatable about a horizontal axis. With this design, the operation unit can be rotated and inclined at a lower position, improving the easiness to use the operation unit.

The operation unit may be designed to be rotatable about a horizontal axis first and then movable in the upward and downward direction. With this design, the operation unit is first rotated and inclined and then moved in the upward and downward direction, making it possible to identify a position at which a user can look at the operation unit in the upward and downward direction.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a configuration of a multifunction copying machine according to a first embodiment of the present invention;

FIG. 2 is a diagram showing the appearance of the multifunction copying machine of FIG. 1;

FIG. 3 is a block diagram showing a configuration of a control box of FIG. 1;

FIGS. 4A to 4D are diagrams showing the appearance of an operation unit of FIG. 2, where FIG. 4A is a plan view, FIG. 4B is a right side elevation, FIG. 4C is a left side elevation, and FIG. 4D is a front elevation;

FIG. 5 is a diagram exemplarily showing the appearance of a console section of FIGS. 4A to 4D;

FIG. 6 is a diagram exemplarily showing the positional relation of a housing, the console section, and a console moving mechanism;

FIG. 7 is a diagram showing the appearance of the console moving mechanism of FIG. 6;

FIG. 8 is a simplified diagram for explaining the mechanism of movement of each component of the console moving mechanism;

FIGS. 9A and 9B are diagrams for explaining the states of the console moving mechanism in a case where a height fixation releasing switch is switched on (FIG. 9B), and in a case where the height fixation releasing switch is switched off (FIG. 9A);

FIG. 10 is a block diagram showing a configuration of a multifunction copying machine according to a second embodiment of the present invention;

FIGS. 11A to 11D are diagrams showing the appearance of an operation unit according to the second embodiment of the present invention, where FIG. 11A is a plan view, FIG. 11B is a right side elevation, FIG. 11C is a left side elevation, and FIG. 11D is a front elevation;

FIG. 12 is a diagram showing the appearance of a robot arm of FIG. 10;

FIG. 13 is a diagram exemplarily showing that a console section C is moved by movement of the robot art;

FIG. 14 is a flowchart for explaining a console position adjusting process; and

FIG. 15 is a diagram showing an example of a screen for prompting a user to set a position to which the operation unit is to be moved.

### DETAILED DESCRIPTION OF THE PREFERRED EMBODIMENTS

The office machine according to the embodiments of the present invention will now be explained with reference to the drawings, by employing a multifunction copying machine having a scanner, a facsimile, etc. as an example.

(First Embodiment)

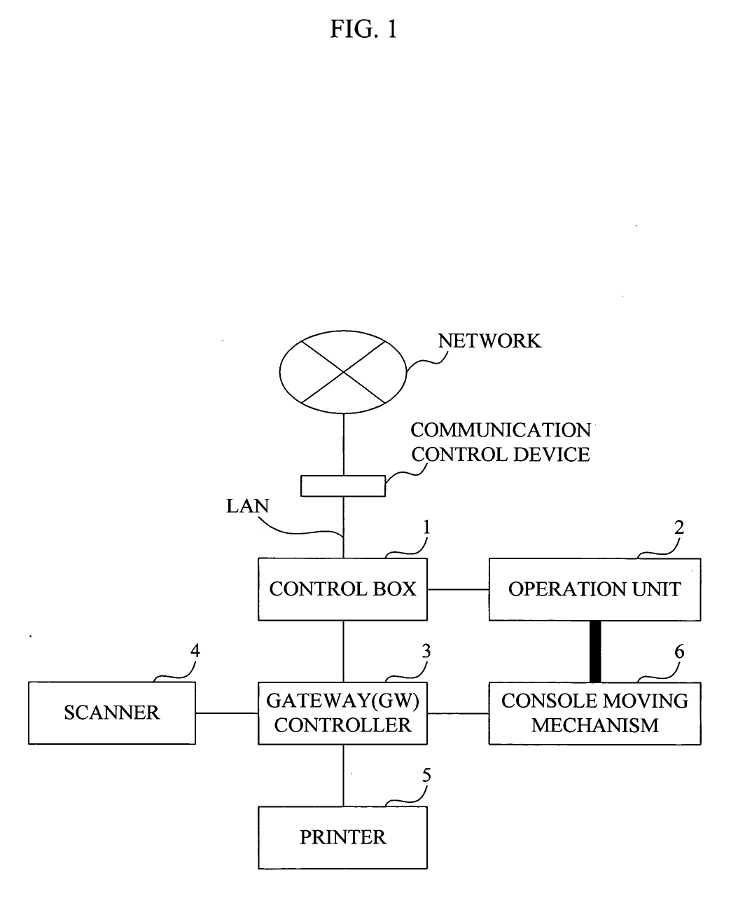

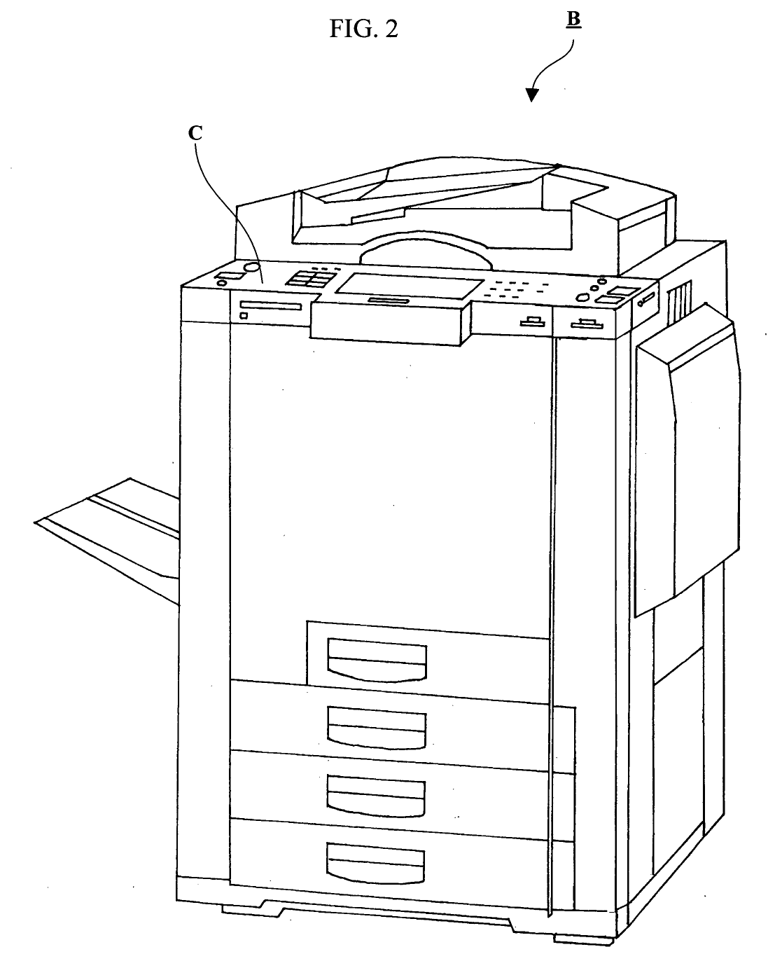

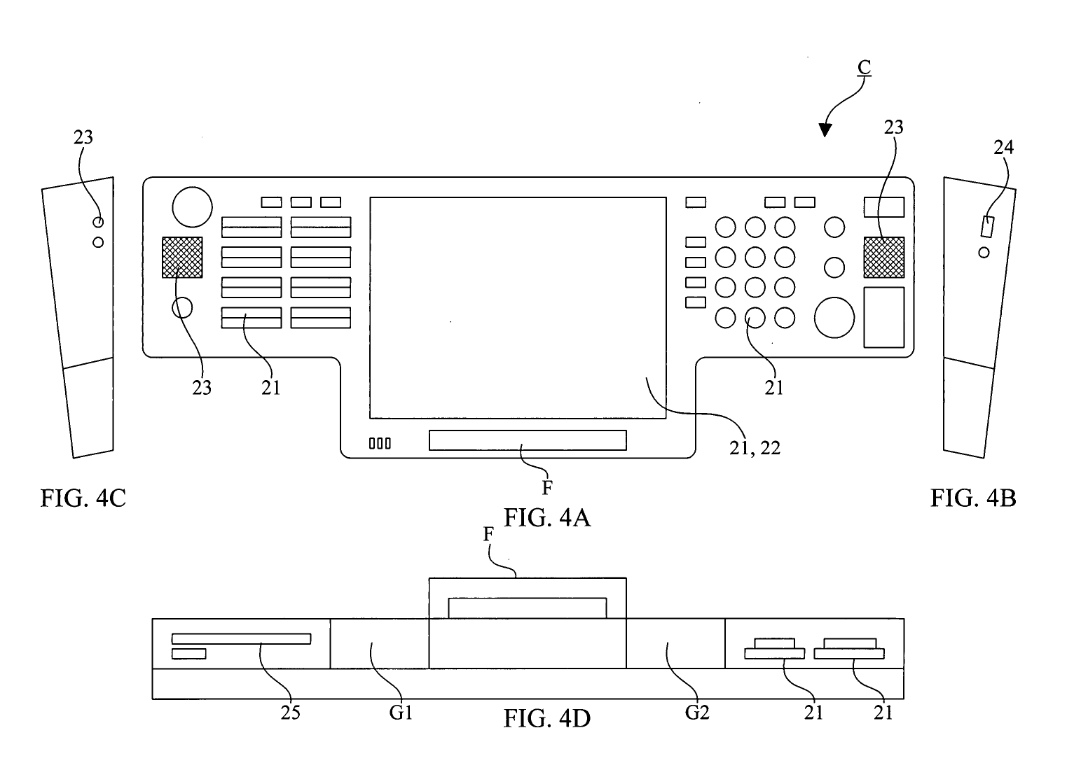

FIG. 1 is a diagram showing the configuration of a multifunction copying machine according to the first embodiment of the present invention. As shown in FIG. 1, this multifunction copying machine comprises a control box 1, an operation unit 2, a GW (GateWay) controller 3, a scanner 4, a printer 5, and a console moving mechanism 6. As shown in FIG. 2, this multifunction copying machine is formed as a complex machine having a housing B, and comprises a console section C. The console section C shown in FIG. 2 is mere a schematic diagram, and will be explained later in detail with reference to FIGS. 4A to 4D.

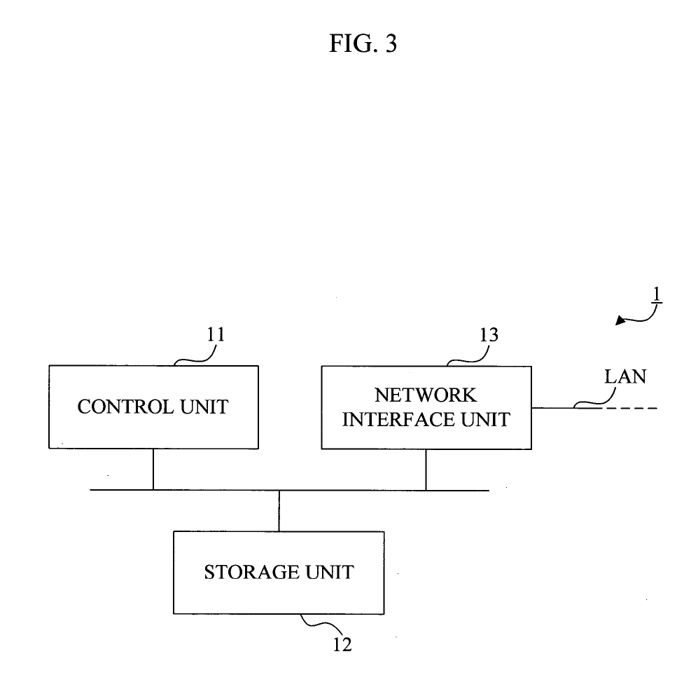

As shown in FIG. 3, the control box 1 comprises a control unit 11, a storage unit 12, and a network interface unit 13. The storage unit 12 and the network interface unit 13 are connected to the control unit 11 via an internal bus.

The control unit 11 comprises a processor such as a CPU (Central Processing Unit) or the like, a volatile memory such as a RAM (Random Access Memory) for providing a work area of the processor, and a specialized circuit for controlling each unit of the operation unit 2 in accordance with an instruction of the processor. The control unit 11 performs various processes such as a scanning process, a printing process, a facsimile sending and receiving process, a height adjusting control process, etc. in accordance with programs stored in the storage unit 12.

The storage unit 12 is constituted by a non-volatile memory such as a hard disk device, an SRAM (Static RAM), or the like. The storage unit 12 pre-stores programs for controlling the control unit 11 to perform the scanning process, printing process, facsimile sending and receiving process, height adjusting control process, etc. The storage unit 12 supplies the programs stored therein to the control unit 11 in accordance with an instruction from the control unit 11.

The network interface unit 13 is constituted by a LAN (Local Area Network) interface circuit or the like. The network interface circuit 13 is connected to the control unit 11 as described above and also to an external LAN as shown in FIG. 1 for intermediating between the control unit 11 and an external apparatus for their data exchange via the LAN. As shown in FIG. 1, this LAN is connected to a network including a telephone line, the Internet, and the like via a communication control device such as a modem or the like. The network interface unit 13 also intermediates between the control unit 11 and an external apparatus for facsimile transmission and data exchange via the LAN and this network.

As shown in FIGS. 4A to 4D, the operation unit 2 comprises an input unit 21, a display unit 22, an audio output unit 23, a radio input/output unit 24, and a height fixation releasing instruction unit 25. Any of the input unit 21, the display unit 22, the audio output unit 23, the radio input/output unit 24, and the height fixation releasing instruction unit 25 is connected to the control unit 11 of the control box 1.

The input unit 21 is constituted by a touch panel, a pressure sensitive pad, and the like. When a user performs operations such as pushing the touch panel or drawing a character or a figure on the pressure sensitive pad by using a stylus pen or the like, the input unit 21 supplies data corresponding to these operations (for example, data associated with the position pushed by the user on the touch panel or data representing the character or the figure drawn on the pressure sensitive pad) to the control unit 11.

The display unit 22 is constituted by a liquid crystal display or the like. The display unit 22 displays a character or a figure corresponding to an instruction of the control unit 11 on its display screen.

The audio output unit 23 is constituted by a speaker, a low-frequency amplifier, a headphone jack, etc., and outputs an audio in accordance with an instruction of the control unit 11.

The radio input/output unit 24 is constituted by an interface circuit or the like for Bluetooth^{(RM)}, and intermediates between an external apparatus connected thereto by radio and the control unit 11 for their communication.

The height fixation releasing instruction unit 25 is constituted by a push switch or the like, and keeps supplying a status signal of a predetermined level to the control unit 11 while the switch is depressed. The height fixation releasing instruction unit 25 is used for releasing fixation of the height of the console in a later-described height adjusting control process.

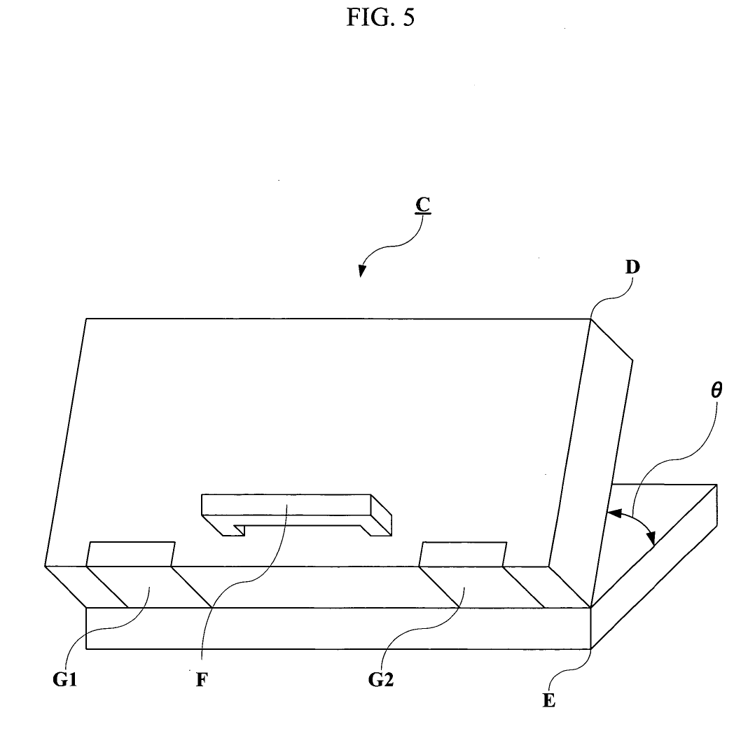

The operation unit 2 is concentratively disposed on the console section C of the housing B as shown in FIG. 2 and FIGS. 4A to 4D, so that it can be easily operated by an operator. FIG. 4A is a diagram showing the top surface of the control section C, FIG. 4B is a diagram showing the right side surface of the console section C, FIG. 4C is a diagram showing the left side surface of the console section C, and FIG. 4D is a diagram showing the front side surface of the console section C. The console section C is in contact with the console moving mechanism 6 formed inside the housing B, as shown in FIG. 5.

As shown in FIG. 5, the console section C comprises a movable section D, a fixed section E, a handle section F, and hinge sections G1 and G2. The movable section D and the fixed section E are connected to each other by the hinge sections G1 and G2. When a user pulls the handle section F, the movable section D rotates about the hinge sections G1 and G2 and rises upward. The hinge sections G1 and G2 rotates within a fixed range, and the angle between the movable section D and the fixed section E is maintained at a predetermined angle θ by an unillustrated stopper mechanism provided in the vicinity of the hinge sections G1 and G2.

The GW controller 3 is constituted by a specialized circuit, or constituted by a processor such as a CPU or the like and a volatile memory such as a RAM or the like for providing a work area for the processor. The GW controller 3 is connected to the control unit 11 of the control box 1, the scanner 4, the printer 5, and the console moving mechanism 6. The control unit 11 of the control box 1 may perform the function of the GW controller 3.

The GW controller 3 instructs the scanner 4 to perform scanning, in accordance with an instruction supplied from the control unit 11. When supplied with image data representing an image acquired by scanning from the scanner 4, the GW controller 3 supplies this image data to the control unit 11. Further, the GW controller 3 instructs the printer 5 to print a character or a figure represented by print data supplied from the control unit 11, in accordance with an instruction supplied from the control unit 11.

The scanner 4 is connected to the GW controller 3. When instructed by the GW controller 3 to perform scanning, the scanner 4 reads a script (a sheet made from paper or the like) placed on a scanning surface of the scanner 4 in accordance with this instruction, and supplies data representing the image of the read script to the GW controller 3.

The printer 5 is connected to the GW controller 3. When instructed by the GW controller 3 to perform printing, the printer 5 prints a character or a figure notified by the control unit 11 on the surface of a sheet made from paper or the like.

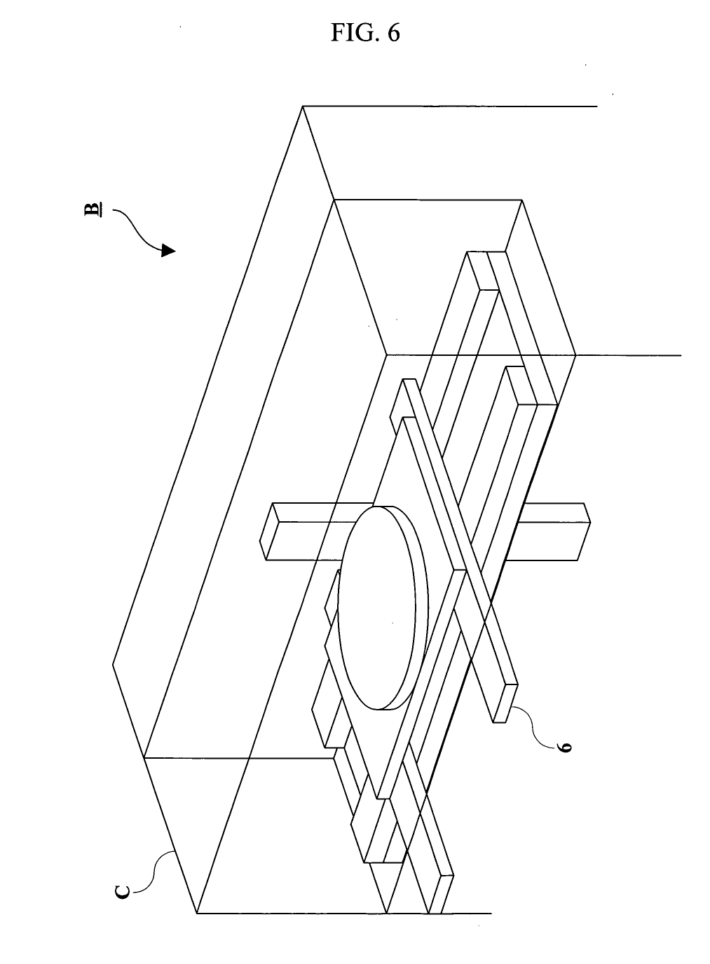

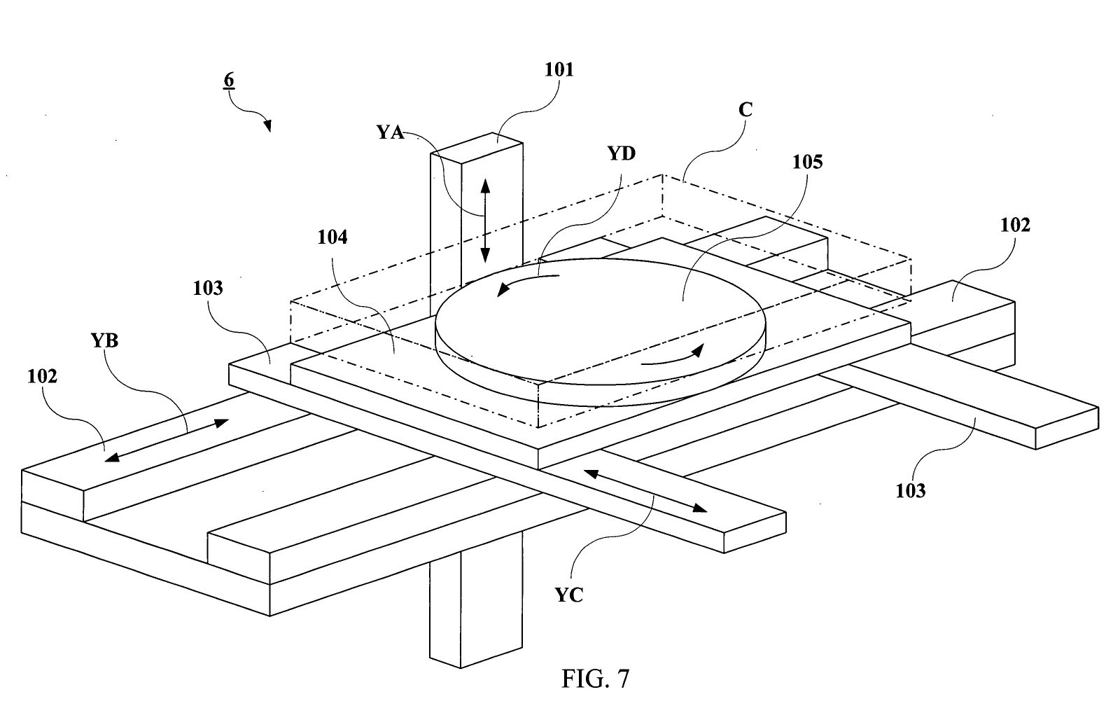

The console moving mechanism 6 is formed inside the housing B as shown in FIG. 6. The console moving mechanism 6 is in contact with the console section C and controls the position of the console section C. The console moving mechanism 6 is constituted by a combination of an XY table device and a turn table device. As shown in FIG. 7, the console moving mechanism 6 comprises a support pillar 101, an upward and downward sliding unit 102, a lateral direction sliding unit 103, a frontward and backward sliding unit 104, and a rotational moving unit 105. The console moving mechanism 6 is connected to the GW controller 3, and performs a later-described height adjusting control process in accordance with an instruction of the GW controller 3.

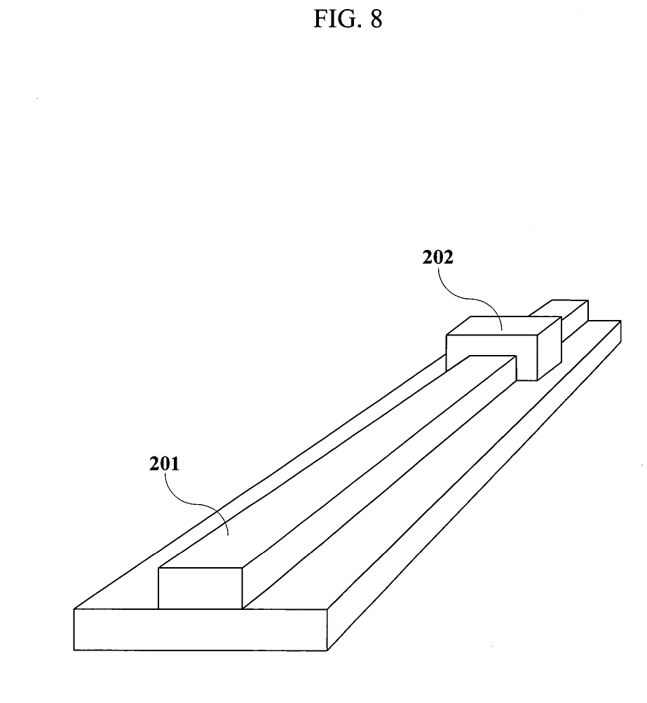

A guide rail as exemplarily shown in FIG. 8 is laid on the support pillar 101 in the longitudinal direction thereof (in the direction indicated by an arrow YA in FIG. 7). Rolling grooves are formed at both sides of the guide rail, and are filled with multiple balls as rolling elements in a rollable manner. A slider is formed on a surface of the upward and downward sliding unit 102 that faces the support pillar 101. By this slider moving along the guide rail via the balls, the upward and downward sliding unit 102 can move upon the support pillar 101 along the guide rail. Likewise, the upward and downward sliding unit 102 and the lateral direction sliding unit 103 are formed such that the lateral sliding unit 103 can move upon the upward and downward sliding unit 102 in a direction indicated by an arrow YB in FIG. 7 by means of a guide rail formed on the upward and downward sliding unit 102 and a slider provided to the lateral direction sliding unit 103. Likewise, the frontward and backward sliding unit 104 is formed such that it can move upon the lateral direction sliding unit 103 in a direction indicated by an arrow YC in FIG. 7.

The rotational moving unit 105 is connected to the frontward and backward sliding unit 104 via an unillustrated coupling piece, and is formed so as to be rotatable on the frontward and backward sliding unit 104. The rotational moving unit 105 is directly connected to the console section C.

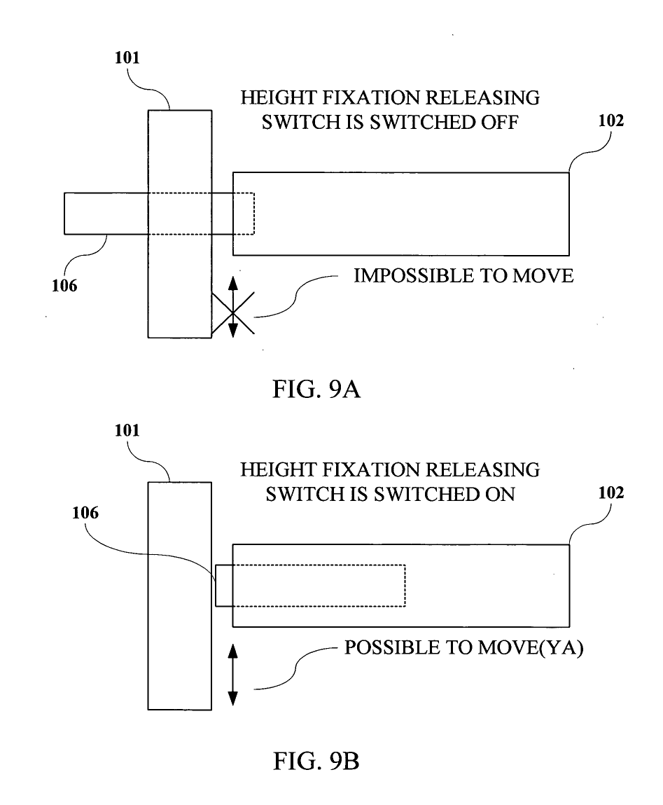

As shown in FIGS. 9A and 9B, the upward and downward sliding unit 102 has a stopper 106 thereinside. The stopper 106 protrudes to the outside of the upward and downward sliding unit 102 as shown in FIG. 9A in a normal state, and thereby fixes the positional relation between the upward and downward sliding unit 102 and the support pillar 101. This is for preventing a drop of the upward and downward sliding unit 102 that might be caused by a factor beyond the control of a user, such as, for example, the gravitational force, etc. Therefore, though it has been explained that the upward and downward sliding unit 102 can move upon the support pillar 101, the upward and downward sliding unit 102 can actually move thereupon only in a case where a certain condition is satisfied. Specifically, when the switch of the height fixation releasing instruction unit 25 is depressed in a later-described height adjusting control process, the stopper 106 is included in the upward and downward sliding unit 102 as shown in FIG. 9B and thereby the upward and downward sliding unit 102 can move upon the guide rail of the support pillar 101. The lateral direction sliding unit 103, the frontward and backward sliding unit 104, and the rotational moving unit 105 also have the stopper 106 thereinside, respectively.

The height adjusting control process is a process for designating the movement of the upward and downward sliding unit 102 of the console moving mechanism 6. First, the height fixation releasing instruction unit 25 sends a status signal of a predetermined level to the control unit 11 when the switch thereof is depressed. While receiving the status signal, the control unit 11 sends an instruction to the GW controller 3 so that the stopper 106 of the console moving mechanism 6 will be included in the upward and downward sliding unit 102.

According to the above-described configuration, the user of the multifunction copying machine according to the present embodiment can operate the operation unit 2 in a state where it is easy to use the operation unit 2, by adequately moving the position of the console section C.

(Second Embodiment)

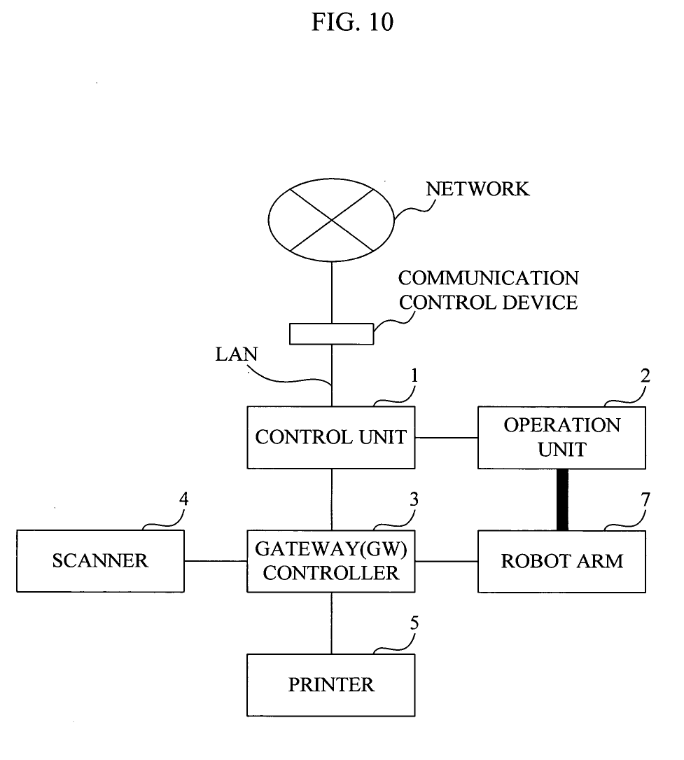

FIG. 10 is a diagram showing the configuration of a multifunction copying machine according to the second embodiment of the present invention. This multifunction copying machine according to the present invention comprises a control box 1, an operation unit 2, a GW controller 3, a scanner 4, a printer 5, and a robot arm 7, as shown in FIG. 10. As well as the above-described first embodiment, the present multifunction copying machine is formed as a complex machine having a housing B, and comprises a console section C.

The differences between the multifunction copying machine according to the present embodiment and the multifunction copying machine according to the first embodiment are that the multifunction copying machine of the present embodiment comprises the robot arm 7 in place of the console moving mechanism 6, and that the configuration of the operation unit 2 is changed in accordance with the replacement of the console moving mechanism 6 with the robot arm 7. In the following description, explanation of the components of the multifunction copying machine of the present embodiment that are the same as those in the first embodiment will be omitted.

The storage unit 12 is constituted by a non-volatile memory such as a hard disk device, an SRAM (Static RAM) or the like. The storage unit 12 pre-stores programs for controlling the control unit 11 to perform various processes such as a scanning process, a printing process, a facsimile sending and receiving process, a console position adjusting process, etc. Further, the storage unit 12 stores later-described user data in accordance with a user's operation. In accordance with instructions from the control unit 11, the storage unit 12 supplies programs and data such as user data or the like to the control unit 11, or updates data and stores new data in accordance with access thereto by the control unit 11.

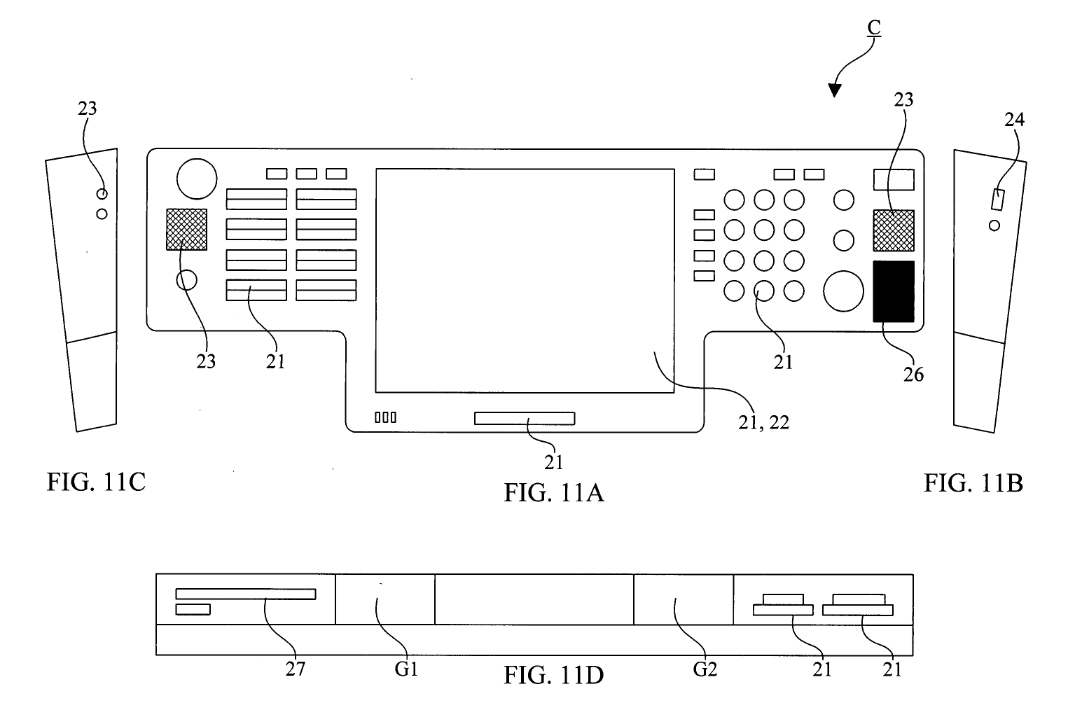

As shown in FIGS. 11A to 11D, the operation unit 2 comprises an input unit 21, a display unit 22, an audio output unit 23, a radio input/output unit 24, a fingerprint input unit 26, and a position reset instruction unit 27. All of the input unit 21, the display unit 22, the audio output unit 23, the radio input/output unit 24, the fingerprint input unit 26, and the position reset instruction unit 27 are connected to the control unit 11 of the control box 1.

The fingerprint input unit 26 is constituted by a scanner or the like. When a finger of a user or the like is put on the scanning surface of the fingerprint input unit 26 and then an instruction from the control unit 11 is received, the fingerprint input unit 26 reads the fingerprint of this finger in accordance with the instruction and supplies data representing the image of the read fingerprint to the control unit 11.

The position reset instruction unit 27 is constituted by a push switch or the like. When the switch is depressed, the position reset instruction unit 27 supplies an interrupt signal of a predetermined level to the control unit 11. The position reset instruction unit 27 is used for returning the position of the console section C adjusted by the robot arm 7 in a later-described console position adjusting process to a predetermined initial position.

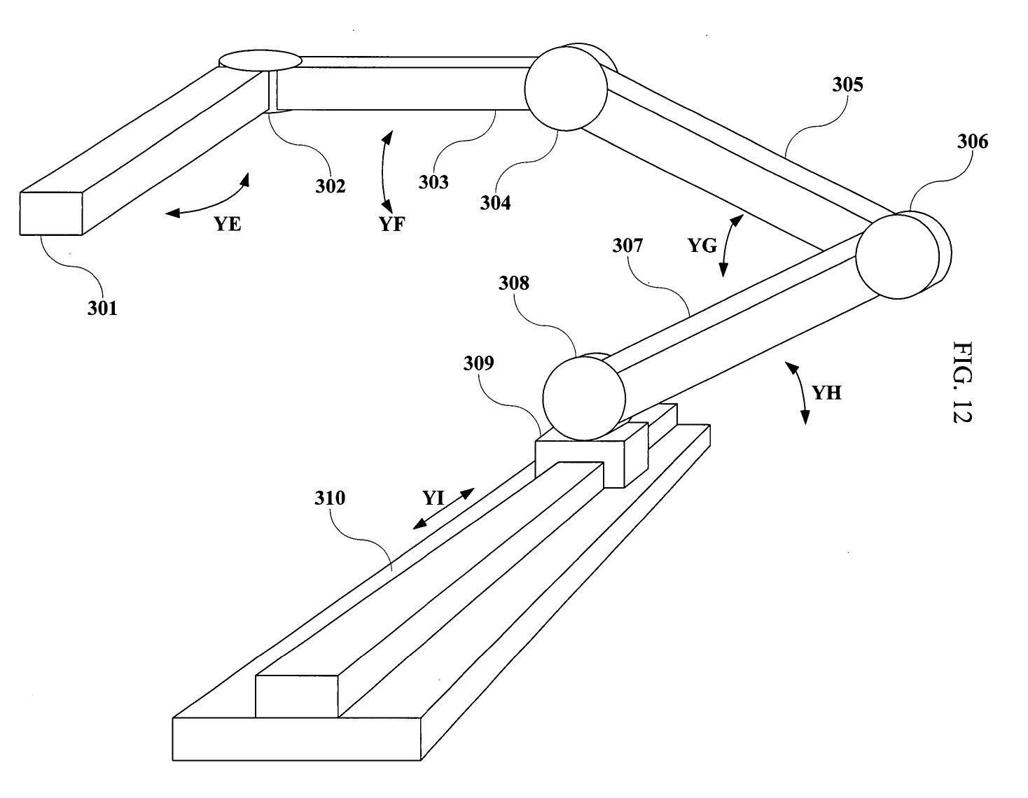

As exemplarily shown in FIG. 12, the robot arm 7 comprises a first arm 301, a first joint 302, a second arm 303, a second joint 304, a third arm 305, a third joint 306, a fourth arm 307, a fourth joint 308, a slider 309, a support 310, and an unillustrated servomotor. Each joint (first joint 302, second joint 304, third joint 306, and fourth joint 308) and the slider 309 are each connected directly to the servomotor. The robot arm 7 is connected to the GW controller 3. When instructed by the GW controller 3 to move the console section C, the robot arm 7 drives the servomotor thereof to move each joint and the slider 309 in accordance with this instruction. By rotation of the first joint 302, the first arm 301 moves in a horizontal direction (in a direction indicated by an arrow YE in FIG. 12). Likewise, the second arm 303 moves in a direction indicated by an arrow YF by rotation of the second joint 304, the third arm 305 moves in a direction indicated by an arrow YG by rotation of the third joint 306, and the fourth arm 307 moves in a direction indicated by an arrow YH by rotation of the fourth joint 308. The slider 309 moves in a direction indicated by an arrow YI in FIG. 12 by the servomotor being driven.

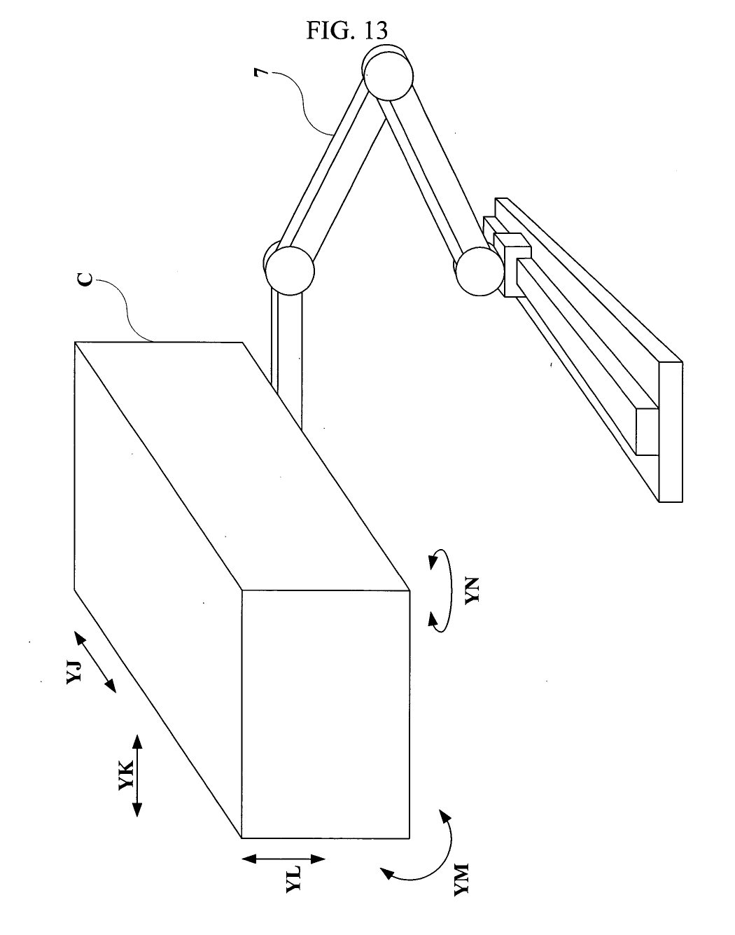

The console section C is secured to the end position of the first arm 301 and thus connected to the robot arm 7. Therefore, as shown in FIG. 13, in accordance with movement of each part of the robot arm 7, the console section C moves in five directions, namely orthogonal coordinate directions (YJ direction, YK direction, and YL direction) and axial rotation directions (YM directions and YN direction).

User data is data associating the fingerprint of a user who operates the operation unit 2 with information on the position of the operation unit 2 set by the user. The user data is stored in the storage unit 12 and is supplied to the control unit 11 in accordance with access by the control unit 11.

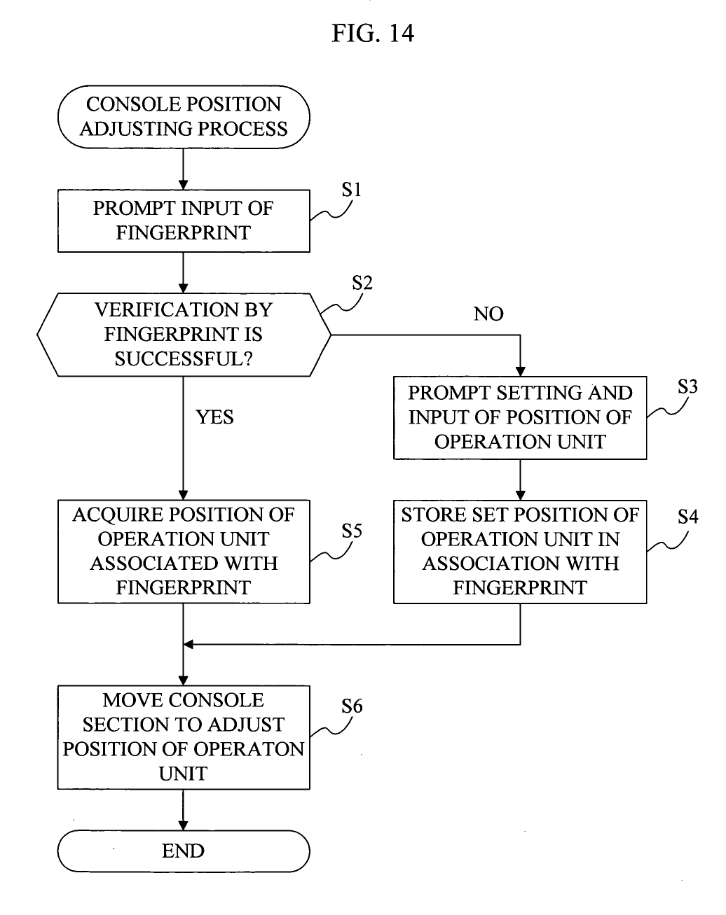

Next, a consol position adjusting process will be explained with reference to FIG. 14. First, the control unit 11 reads a program for the consol position adjusting process from the storage unit 12 in response to an instruction from a user operating the operation unit 2 (hereinafter referred to as “user”). In accordance with the program, the control unit 11 displays an image for prompting the user to input his/her fingerprint, on the display unit 22 of the operation unit 2 (step S1).

When data representing the image of the fingerprint is supplied from the fingerprint input unit 26 in accordance with an operation of the user, the control unit 11 verifies whether the supplied data represents a fingerprint of a valid user, based on the user data (step S2). When the verification is successful (i.e., when determining that the supplied data represents a fingerprint of a valid user), the control unit 11 skips to step S5 (step S2: YES).

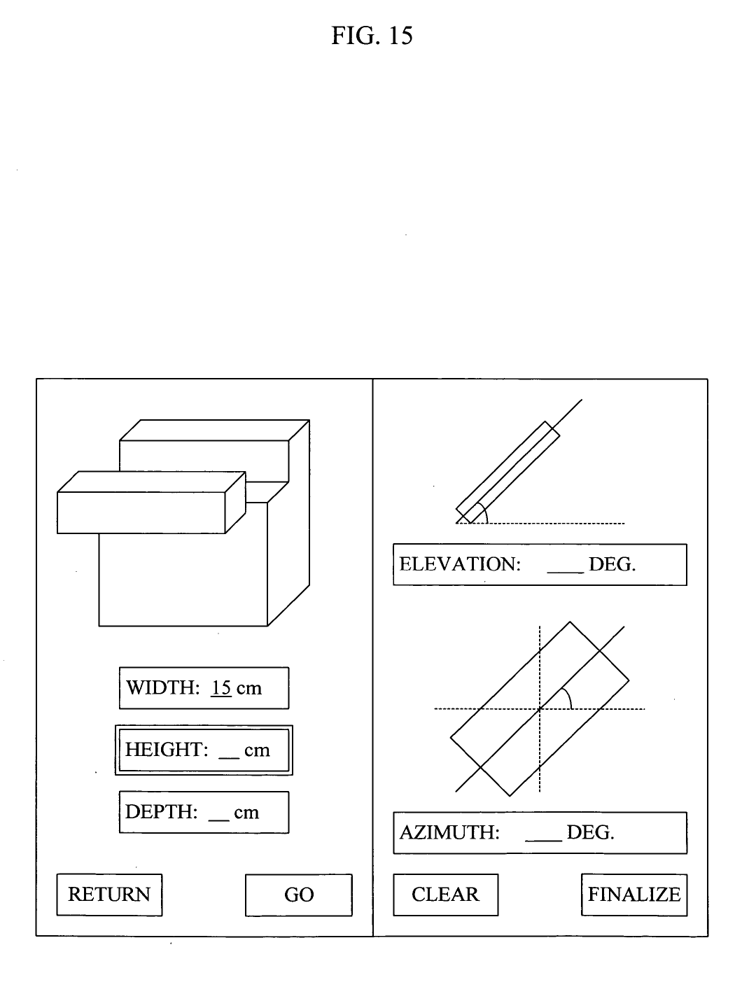

To the contrary, when the verification is unsuccessful (step S2: NO), the control unit 11 displays an image (for example, the image shown in FIG. 15) for prompting the user to set and input the user's desired position of the operation unit 2 (horizontal position, height, and angle), on the display unit 22 (step S3). By operating the operation unit 2, the user sets and inputs the position at which he/she wants to use the operation unit 2.

The positional information of the operation unit 2 set and input by the user is supplied to the control unit 11. The control unit 11 associates the input positional information of the operation unit 2 and the data representing the image of the fingerprint that has failed in verification in step S2 with each other, and stores the associated data in the storage unit 12 as new user data (step S4) and goes to step S6.

In step S5, the control unit 11 acquires positional information of the operation unit 2 that is associated with the image data of the fingerprint of the successfully verified user from the user data (step S5).

In step S6, the control unit 11 supplies the acquired positional information of the operation unit 2 to the GW controller 3. The GW controller 3 receives the positional information of the operation unit 2, and adjusts the position of the console section C in accordance with the received positional information of the operation unit 2 by driving the servomotor of the robot arm 7 to move each joint and slider 309 of the robot arm 7 (step S6). Through these steps, the position of the console section C is adjusted.

According to the above-described configuration, it is possible for the user to operate the operation unit 2 at a position suitable for him/her to use the operation unit 2 by letting his/her own fingerprint be read by the multifunction copying machine without moving the operation unit 2 by him/herself.

As explained above, according to these embodiments, short users or users in wheelchairs can more easily operate the operation unit by moving the operation unit closer to themselves or to a lower position. The operation unit may be designed to be rotatable about a horizontal axis so that it can be inclined. With this design, for example, short users or the like may not need to take a hard position to overlook the operation unit. Further, if the operation unit is designed to be movable downward first and then rotatable about a horizontal axis, the operation unit can be rotated to be inclined at a lower position. This would further increase the easiness to use the operation unit. If the operation unit is designed to be rotatable about a horizontal axis first and then movable upward and downward, it becomes easy to identify a position at which the operation unit can be easily looked at, by rotating and inclining the operation unit first and moving it upward or downward.

The present invention is not limited to the above-described embodiments, but may be modified and applied in various manners.

The mechanical structures of the console moving mechanism 6 and the robot arm 7 may only need to be linearly movable in the horizontal direction and in the vertical direction and rotatable in the horizontal direction and in the vertical direction, and therefore are not limited to the above-described embodiments.

According to the first embodiment, the position of the console section C is adjusted by user taking the handle section F. However, the present invention is not limited to this. For example, the console section C may have a groove having a width that allows a man's finger to be inserted, so that the console section C can be moved by a user holding the groove.

According to the second embodiment, the position of the operation unit 2 (console section C) is automatically set based on a user's fingerprint. However, the operation unit 2 may be designed such that its position can be changed manually for fine tuning or in case of emergency.

According to the second embodiment, users are verified by their fingerprint. However, users may be verified by, for example, a photo of their face or the like.

Cases where the present invention is applied to a multifunction copying machine have been explained as examples. However, the present invention is not limited to a multifunction copying machine but may be widely applied to office machines such as a facsimile machine, a copying machine, a printing machine, etc. Particularly, the present invention can suitably be applied to a comparatively tall apparatus such as an in-trunk sheet discharge type apparatus that has a home position for its operation unit at a position at which users in wheelchairs can not easily operate the operation unit.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2003-205179 filed on Jul. 31, 2003 and including specification, claims, drawings and summary. The disclosure of the above Japanese Patent Application is incorporated herein by reference in its entirety.

1. An office machine having an operation unit, said office machine comprising:
a housing;
a processing unit which operates in accordance with a content of an instruction from an operator of said office machine and which is provided inside said housing; and
an operation unit which is formed so as to be movable with respect to said housing.

2. The office machine according to claim 1, comprising:
a printing section which performs printing on a sheet of paper; and
a discharging section of an in-trunk sheet discharge type which discharges a sheet of paper on which printing is performed by said printing section.

3. The office machine according to claim 1, comprising
a stopper which supports said operation unit so as not to move with respect to said housing, when said office machine is operating.

4. The office machine according to claim 1,
wherein said operation unit is formed so as to be movable in a frontward and backward direction when seen from an operator of said office machine.

5. The office machine according to claim 1,
wherein said operation unit is formed so as to be movable in an upward and downward direction when seen from an operator of said office machine.

6. The office machine according to claim 1,
wherein said operation unit is formed so as to be movable in a leftward and rightward direction when seen from an operator of said office machine.

7. The office machine according to claim 1,
wherein: said operation unit is supported rotatably about a predetermined horizontal axis; and
said office machine comprises a holding member which holds said operation unit at an arbitrary angle to a horizontal plane.

8. The office machine according to claim 1, comprising
a driving unit which moves said operation unit to a position desired by an operator in accordance with an instruction from the operator.

9. The office machine according to claim 8, comprising:
a storage unit which stores setting information representing displacement from a home position for each operator; and
wherein said processing unit activates said driving unit in accordance with the setting information in order to control said driving unit to move said operation unit to a position desired by an operator.

10. The office machine according to claim 9, wherein:
said operation unit includes an input unit which acquires verification data for verifying an operator;
said storage unit is for storing the verification data for each operator in one to one correspondence to the setting information;
said office machine comprises a determination unit which determines whether or not verification data input from said input unit is stored in said storage unit; and
said processing unit, in a case where said determination unit determines that verification data input from said input unit is stored in said storage unit, activates said driving unit to move said operation unit to a position desired by a operator based on setting information associated with the input verification data, and in a case where said determination unit determines that verification data input from said input unit is not stored in said storage unit, stores displacement of said operation unit from the home position at a time in question, in said storage unit as setting information in association with the verification data input from said input unit.

11. An office machine, comprising:
a housing;
a printing section;
a discharging section which discharges a printed sheet of paper;
an operation unit for inputting an instruction to at least said printing section; and
an operation unit supporting section which supports said operation unit in a manner that said operation unit is movable with respect to said housing.

12. The office machine according to claim 11, comprising
a driving unit which moves said operation unit to a position designated by an operator,
wherein said operation unit receives designation of the position from the operator.
